(19) United States
(12) Patent Application Publication
(10) Pub. No.: US 2010/0030872 A1
(43) Pub. Date: Feb. 4, 2010

(54) System for remote processing, printing, and uploading of digital images to a remote server via wireless connections

(76) Inventors: Serge Caleca, Escondido, CA (US); Tim Justice, Poway, CA (US); Steven Chua, San Diego, CA (US)

Correspondence Address: ERIC HANSCOM, 7395 PORTAGE WAY, CARLSBAD, CA, 92011, US

(21) Appl. No.: 12/389,708

(22) Filed: Feb. 20, 2009

Related U.S. Application Data
(60) Provisional application No. 61/086,088, filed on Aug. 4, 2008.

(51) Int. Cl. G06F 15/16; H04N 5/225; G06F 3/12

(52) U.S. Cl. 709/219; 348/207.2; 358/1.15; 348/207.1; 348/E05.024

(57) ABSTRACT

A system that includes a digital camera, a digital image processing unit, a printer, and a remote server. The digital camera wirelessly transmits a digital image to the digital image processing unit. The digital image processing unit, once it receives the digital image, can store the image locally on a hard disk and print the digital image. The digital image processing unit can also include a mobile internet card, thereby enabling it to connect directly to the internet to upload the stored digital images directly to a remote server without first needing to connect to a local network. Alternatively, the camera and the digital image processing unit can be one and the same, and transmit the digital image wirelessly to a printer, a remote server, or both. The settings and preferences of the system can also be updated automatically when it connects to a remote server.

### CROSS REFERENCE TO RELATED APPLICATIONS

This application is a non-provisional application of U.S. Provisional Patent No. 61/086,088 filed Aug. 4, 2008, the entirety of which is hereby incorporated by reference.

### STATEMENT REGARDING FEDERALLY SPONSORED RESEARCH OR DEVELOPMENT

This invention was not federally sponsored.

### INVENTORS

Serge Caleca, Steven Chua, Tim Justice

### BACKGROUND OF THE INVENTION

### Field of the invention

This invention relates to the general field of photography, and more specifically toward a system that includes a digital camera, a digital image processing unit, and a remote server. The digital camera, once a digital image has been taken, can transmit this image wirelessly to the digital image processing unit. The digital image processing unit, once it receives the digital image, can store the image locally on a hard disk or other means of electronic storage and also print the photo using an integrated printer capable of producing high quality digital prints. The digital image processing unit can also include a mobile internet card, whereby the digital image processing unit can connect directly to the internet using the mobile internet card and upload the stored digital images directly to a remote server without first needing to connect to a local network. This creates a system where a digital image can be taken and then printed immediately as well as uploaded to a remote server and made available over the internet almost instantaneously. Alternatively, the camera and the digital image processing unit can be one and the same, and transmit the digital image wirelessly to a printer, a remote server, or both. The settings and preferences of the system can also be updated automatically when it connects to a remote server.

Photography enables the documentation of a specific visual event. A photograph captures a visual image to be viewed at a later date. There are many occasions where it is desirable to quickly and easily provide customized photographers to the subjects being photographed. Historically, cameras required film that had to be developed using special techniques. This meant that a photograph taken with a camera could not be viewed for quite some time until it was developed by a professional photographer. Polaroid® cameras have enabled consumers to take a photograph and have that photograph printed in a short period of time. It provides a convenient means for distributing a photograph without having to take the film to get professionally developed. However, the images produced by the Polaroid® camera are often of mediocre quality, are relatively, small, and lack and personalization or logos that the photography may wish to place over the photograph, and are generally not easily duplicated to create multiple prints of the same photograph. Therefore, it would be desirable to have a system that can quickly and easily provide high-quality customized photographs that are quickly available after the photograph has been taken.

### SUMMARY OF THE INVENTION

The system of the current invention is focused around a digital image processing unit. The digital image processing unit is a self-contained device. The digital image processing unit includes a computer that is capable of storing and processing data, a wireless network card, an LCD screen, a means for inputting data into the digital image processing unit, and a mobile internet card. The digital image processing unit can also optionally contain a printer or the printer can be separate from the digital image processing unit and be connected wirelessly or via wired cables. A wireless network card is included with the digital image processing unit to communicate wirelessly with a digital camera. It is contemplated by the inventors that immediately after the digital camera takes a digital image, the digital image is transferred via a wireless local network to the digital image processing unit, specifically to a computer. Once the digital image has been transferred to the digital image processing unit, it can be printed using the integrated or attached printer. The same digital image can also be uploaded to a remote server. The digital image processing unit can connect directly to the remote server over the internet by using the mobile internet card. The LCD screen, optionally a touch screen, can display information to a user as well as accept input from the user. It is also contemplated by the inventor, however, that the digital image processing unit operate without the need of a screen, keyboard, or mouse. In this iteration, the digital image processing unit would be managed remotely through network connections, such as the internet.

Another unique feature of the current invention is its ability to change its settings automatically from a remote location. The computer of the digital image processing unit can connect to a remove server via its internet connection through the mobile internet card. The connection can be made when the computer first turns on, at set intervals, or if manually requested by a user. By connecting to the remote server, the settings and preferences of the system can be modified. This creates a dynamic system that can be used consecutively by multiple different individuals and/or at multiple different events without requiring the user of the invention to change any settings on the system.

It is a principal object of the invention to provide a system where a digital image can be taken with a digital camera and the resulting digital image is wirelessly transferred to a device capable of printing one or more copies of that digital image.

It is another object of the invention to provide a system where a digital image can be taken with a digital camera and the resulting digital image is wirelessly transferred to a device which can then, in turn, upload the digital image to a remote server.

It is an additional object of the invention to provide a system where a digital image can be taken with a digital camera and the resulting image is wirelessly transferred to a printer where it is printed.

It is a further object of the invention to provide a system where a digital image can be taken with a digital camera and the resulting image is wirelessly transmitted to a remote server where it is made available for access over the internet.

It is a final object of this invention to provide a system where the digital image that is printed or uploaded to the remote server has an additional digital image, or graphic, superimposed over the original digital image.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

Communication, as used previously and hereinafter, is intended to mean the transfer of electronic data between two devices.

Wireless communications, as used previously and hereinafter, is intended to mean communication between two or more devices that occurs despite the fact that the two or more devices are not physically connected to each other by means of wires or cables.

### BRIEF DESCRIPTION OF THE FIGURES

FIG. 1 shows an embodiment of the current invention using a digital image processing unit, digital camera, printer, and remote server.

FIG. 2 shows an embodiment of the current invention using a digital image processing unit, printer, and a remote server.

FIG. 3 shows an embodiment of the current invention where the digital image processing unit and printer are the same unit known as a custom built computer box.

### DETAILED DESCRIPTION OF THE INVENTION

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings.

The current invention enables users to quickly take a picture, print it, and make it available over the internet. It can include an image capture device, a digital image processing unit, a printer, a remote server, and means of communicating between the different elements of the invention.

Various different digital cameras are contemplated for use with the current invention. Any device that is capable of taking a digital image and storing it in electronic memory is sufficient. However, it is beneficial if the digital camera can communicate wirelessly with the digital image processing unit. One means to enable standard digital cameras to communicate wirelessly is to use an SD card that includes a means of communicating wirelessly over a wireless local area network. Eye-Fi, Inc. creates such an SD card that can be used for storing digital images as well as transmitting these images wirelessly to a computer or remote server over the internet.

The digital image processing unit is preferably a computer. This computer can be a standalone computer, such as a laptop, that includes a wireless network card, screen, keyboard, mouse or touchpad, and a mobile internet card. Alternatively, the digital image processing unit can be a custom made computer that includes all of these components, some of these components, and/or optionally, a built in printer.

Whether using a laptop, standard computer, or custom built computer, it is preferable to include a mobile internet card that can be exchanged and replaced to meet the changing mobile internet technology. Mobile phone carriers now offer computer cards that enable computers to connect to mobile phone networks to access the internet. This mobile internet technology allows a computer to connect to the internet where there is mobile phone reception. One such card that meets the needs of the current invention and is compatible with current mobile internet technology is the KPC680 ExpressCard (PC Express Socket) or an External USB Modem AC595U, each using the Verizon wireless network. It is nonetheless possible, however, to have the laptop, standard computer, or custom built computer connect to the internet via a local network, wirelessly or through cables. Additionally, it is possible that a wireless router connects to the internet via a mobile internet adapter and the digital image processing unit and the digital camera communicate with each other wirelessly through the network created by the wireless router.

The printer of the current invention can be integrated with the digital image processing unit, or separate from the digital image processing unit. However, if a printer is integrated into the digital image processing unit, it is preferable that the printer can be easily removed and replaced to meet the changing printing technology. External printers that are connected to the digital image processing unit can be connected via wired means, such as a USB cable, or via wireless means, such as Bluetooth.

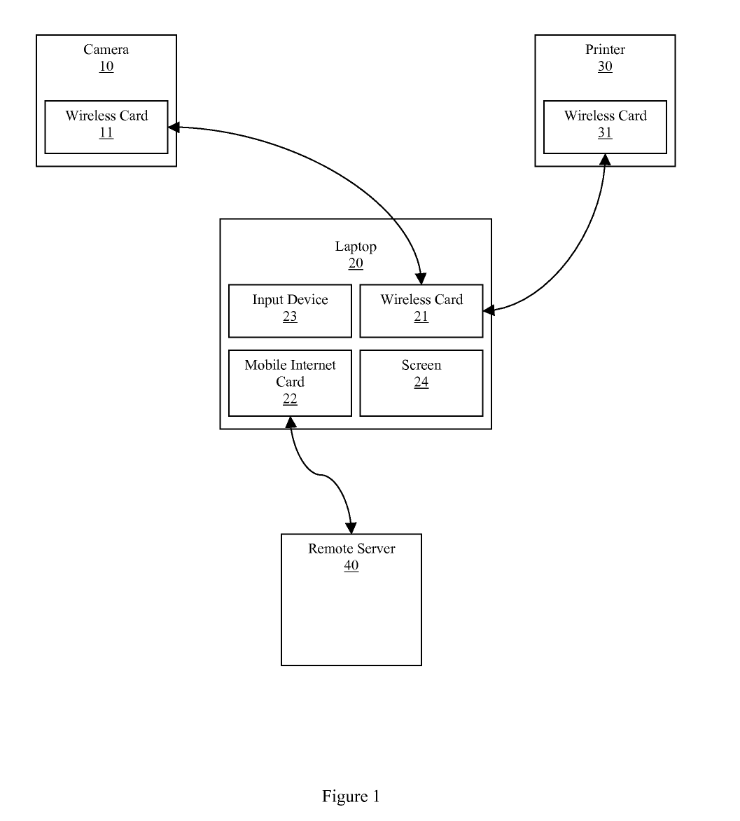

FIG. 1 shows an embodiment of the current invention using a digital image processing unit, digital camera, printer, and remote server. The digital camera 10 should include a wireless card 11 or other means to connect to a wireless local area network to communicate with other devices or, alternatively, thought not preferably, the digital camera 10 can be connected to the digital image processing unit 20 via a wired cable. In this iteration, the digital image processing unit 20 can be a laptop. The digital image processing unit 20 preferably includes a wireless card 21. Built into the digital image processing unit 20 should also be a screen 24 and an input device 23, such as a keyboard and mouse or touchpad. A mobile internet card 22 can be used to communicate with a remote server 40. The wireless card 21 can be used to communicate with the camera 10 and a printer 30, where the printer also has a wireless card 31. An example of a laptop with these components is an Apple MacBook or MacBook Pro with a KPC680 Express Card by Verizon. The printer can be a Sony UP-CX-1 Thermal Dye Printer. The printer can communicate with the laptop via Bluetooth using a Sony Bluetooth USB adapter. Alternatively, the printer and laptop can communicate via other wireless means or a USB cable. It is also possible to include a wireless router in this configuration, such as the LinkSys WTR54GS or Dlink WLG730LP. The wireless router could connect wirelessly to the wireless cards of the various devices. In this iteration, the wireless router would route data passed wirelessly from the laptop, camera, and printer. The wireless router can also include a mobile internet adapter, such that the digital image processing unit connects to the internet via the wireless router. It is also possible for the printer and/or laptop to be connected via wires, such as Ethernet cables to the router, which then communicate wirelessly with the camera. This scenario would require that the printer and/or laptop have Ethernet network cards in place of or in addition to the wireless cards. Additional wireless routers and/or repeaters could be added to the system to increase the range of wireless communication between the devices.

Using the configuration shown in FIG. 1, a user can take a digital image using the digital camera 10. The wireless card 11 will then transmit the photo to the digital image processing unit 20. Alternatively, the digital images can be stored locally on the digital camera 10 and then transferred to the digital processing unit 20 after multiple digital images have been taken. The digital image processing unit includes software that can process photos and send them to a printer and/or a remote server. Upon receiving the digital image, the digital image processing unit 20 can cause the digital image to be printed on a printer 30, where the digital image is sent from the wireless card 21 of the digital image processing unit 20 to the wireless card 31 of the printer 30. A user may view the status of the system on the screen 24 or change the settings of the system via the input device 23. The digital image processing unit 20 can also connect to the internet via a mobile internet card 22. The digital images sent from the camera 10 can be automatically uploaded to a remote server 40 using the mobile internet card 22. This obviates the need for a separate internet connection to the digital image processing unit 20. Once the images are located on the remote server 40, they can be made available for access by other computers over the internet.

Additional data, or information necessary to view the digital image over the internet, must accompany the digital image when it is uploaded to the server to enable users to view their image without having to scan through thousands of others. This data can be transmitted simultaneously with the digital image or at a later time. The data and/or digital image can be stored in an associative database that allows quick and easy access to the digital image. Alternatively, the digital images can be stored in a folder hierarchy that uses folder names to represent key data, such as photography, username, password, etc. and further includes data files to supplement data not easily stored in folder names.

In one embodiment of the current invention, information necessary to view the digital image over the internet is located directly on the printed image. For example, after a digital image has been taken by a camera and transferred to the digital image processing unit, a username and password can be assigned and printed onto the image. This username and password can be used to access that same digital image over the internet. This enables a consumer to obtain a print of the digital image immediately, but also have login information printed directly onto that same image to access, view, and optionally purchase the digital image over the internet. Many alternatives to a username and password are also possible, such as an access key, that can be printed on the image itself that enables a consumer to access the digital image over the internet at a later time.

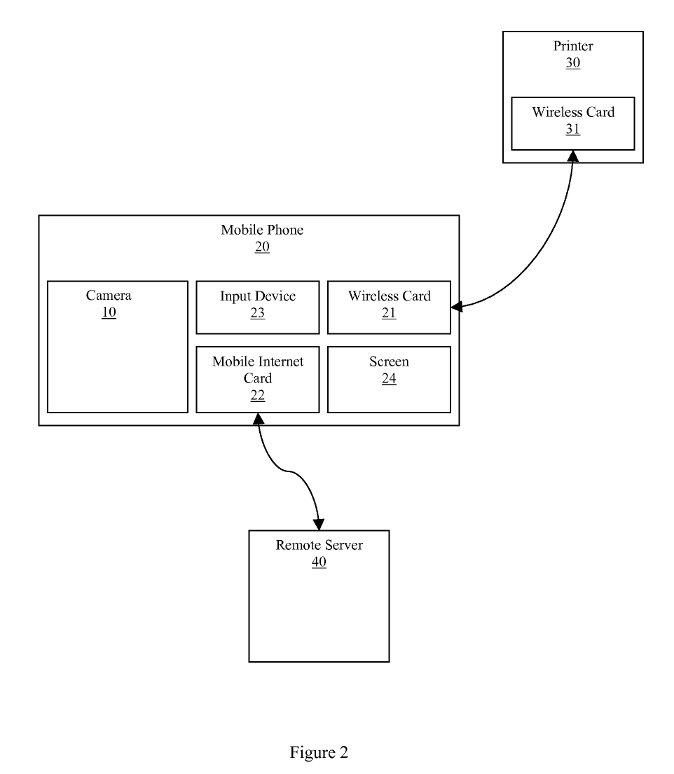

FIG. 2 shows an embodiment of the current invention using a digital image processing unit, printer, and a remote server. In this embodiment, the digital image processing unit 20 includes a camera 10. The digital image processing unit 20 should include a camera 10, input device 23, wireless card 21, screen 24, and mobile internet card 22, or similar means for achieving the same goals. Software must be installed on the digital image processing unit 20 to process digital images that are taken such that they can be printed on a remote server and/or sent to a remote server for later viewing on a remote computer. The Apple iPhone is an example of a digital image processing unit that includes these capabilities. It has camera that can take a picture and the images can be stored on the phone. The user can view data and interact with the device via a touch screen. It includes a means for connecting to wireless networks, which can be used for transmitting the photo to a printer 30 for printing. Since the Apple iPhone can also connect to the internet, the photos can automatically be transmitted to a remote server 40.

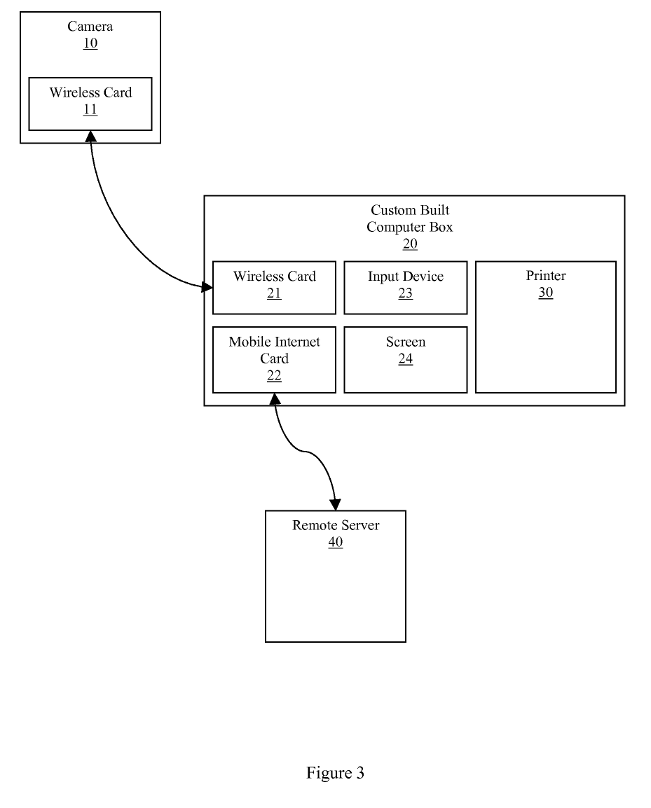

FIG. 3 shows an embodiment of the current invention where the digital image processing unit and printer are the same unit known as a custom built computer box. In this iteration, the digital camera 10 is used to take a picture, which is then transmitted by a wireless card 10 to the wireless card 21 of the digital image processing unit 20. The digital image processing unit includes a screen 24 for viewing the status and other important information of the system, as well as an input device 23 for accepting input from a user. These two devices can be combined into a touch screen to perform both functions simultaneously. The digital image processing unit 20 also includes a printer 30, where the digital image processing unit 20 can automatically cause digital images obtained from the camera 10 to be printed on the printer 30. The digital image processing unit can also send the digital images to a remote server 40 via a mobile internet card 22. It is also envisioned that a wireless router, similar to the one described with FIG. 1, could be integrated into the custom built computer box.

It is envisioned that some or all of the components can be battery powered. This creates a unique system of taking digital images, printing them, and transferring them to a remote server without physically connecting the system to the internet or external power. It is also possible to use multiple components within the same system. For example, multiple cameras may be used to take digital images that are all transferred to the same digital image processing unit. Further, multiple printers could be used to print the images, especially if there is a high volume of digital images that must be printed. Additionally, multiple digital image processing units could be used to process and transfer the images. One such scenario could be where multiple Apple iPhones are used, where each Apple iPhone connects to the same printer, but each Apple iPhone individually connects to the internet and remote server to upload the digital images to the remote server.

The digital images that are processed by the digital image processing unit can have another image placed on top of that image before it is printed and/or uploaded to the remote server. In this fashion, a digital image of an event can be taken by the digital camera and transferred to the digital image processing unit. The digital image processing unit can then place a logo or advertisement over the image thereby creating a new digital image. This new digital image that is a combination of the original digital image and the logo can then be printed such that a print version of the new digital image is available in a short period of time. The same new digital image can also be uploaded to the remote server for viewing, ordering, printing, or other functions that are well known in the art. In other words, the digital image processing unit can overlay a graphic on the digital image thereby creating a composite digital image, where this composite digital image can be printed and/or uploaded to the remote server. Instead of or in addition to the digital image processing unit overlaying a graphic, a graphic can be overlayed by the remote server.

The settings and preferences of the system can be set up by a remote server. It is anticipated by the inventors that the same system will be used by multiple different photographers and/or at multiple different events that require different settings and preferences. [0031 ] For example, the system may be used by Photographer A at Event 1. At this event, Photographer A wishes to have a logo placed over the digital images taken at the event and a single copy of each digital image printed immediately. Photographer A also wants the digital images to be uploaded immediately to a remote server for viewing over the internet. Then, after Photographer A uses the system at Event 1, Photographer B will use the system at Event 2. However, Photographer B has no logo to place over the digital images and would like four copies of each digital image printed immediately. Further, there is no need to post the digital images to a remote server for viewing, as everyone will receive a copy of their digital image at the event.

While it is possible for Photographer B to manually enter her new settings into the system, it would be more efficient and economical for the settings to automatically update on the system such that it is ready to use after Photographer B turns the system on. Photographer B may be unfamiliar with the nuances of the software and hardware, and may have a difficult time entering in the requisite data. Additionally, Photographer B will have to spend additional time in customizing the system to suit her needs, valuable time that could be spent taking digital images. Further, the owner of the system may wish to only allow certain functions, or charge the photographer for the usage of the system, such as charging for the number of prints of the digital images created. Therefore, it is beneficial to have settings on the system to regulate the prints produced and/or keep track of the number of digital images processed, printed, and uploaded.

The system of the current invention is able to update itself automatically with new settings and preferences. Each system has a unique identifier that allows a remote server to identify which system is connecting to the remote server. To set up a system, an administrator can login to the remote server. The administrator preferably enters the settings into a database, where these settings are associated with the unique identifier that identifies the system. These settings can also be associated with a time period, such that different settings are sent to the system of the current invention depending on the date and time that the settings are accessed. The settings can include photographer information, logos, printing settings, and other event information as well as return data. Return data is used after digital images have been taken and are uploaded to the server. The return data identifies where and how the digital images should be stored on the remote server such that they can be accessed by users over the internet. Examples of this information can include the photographer name, event name, and username and password information associated with one or more digital images. Examples of storing this information can be in a database, data files, or folder hierarchical structures. The computer of the digital image processing unit then connects to the remote server via the mobile internet card. Based upon the unique identifier sent to the remote server and, optionally, the date and time the settings are accessed, the remote server returns the settings to the system. Optionally, the system can keep track of the number of digital images processed and/or printed and/or uploaded and return this data to the remote server such that the owner of the system may charge the photographer using the system accordingly.

Returning to the example above, assume that Photographer A will be sent System X for Event 1 on day 1. On day 5, System X will be sent to Photographer B for Event 2. An administrator first logs into the remote server. He then enters in the settings for Photographer A, which would include the system identifier of System X, a logo for placing over the digital images, a setting for each digital image to print once, and settings for the return data for uploading the digital images back to the remote server. Alternatively, the digital images may be uploaded to a different remote server than the one where the settings for the system are stored. The administrator would also set the time period that these settings are valid. The administrator would then also create settings for Photographer B, which would include the system identifier of System X and a setting for each digital image to print four times. As with the settings for Photographer A, the administrator would set the time period that these settings are valid.

When Photographer A receives System X and turns it on, the system automatically connects to the internet using the mobile internet card. The system connects to the remote server to download new settings, if any. In this example, the system would send its unique identifier to the remote server and the remote server would return the corresponding settings. Photographer A can then immediately start taking digital images, and they would automatically be printed to his specifications and uploaded to the remote server such that other users can access the digital images over the internet.

On day 5, the system is sent to Photographer B, who turns it on. The system automatically connects to the internet using the mobile internet card. The system connects to the remote server to download the new settings for Photographer B. Photographer B can then immediately start taking digital images, and they would automatically be printed to her specifications.

Various other methods and alternative means of updating the system with new settings are possible. However, the system should automatically update with new settings for each photographer for ease of use and so that the owner of the system can maintain control and obtain adequate compensation for the system's use.

Users who wish to access their photo can do so through the internet, assuming their photo has been uploaded to a remote server by the digital image processing unit. Once the digital image and the associated data have been transmitted to the remote server, they can be accessed using a system and method similar to that disclosed in U.S. patent application Ser. No. 11/968,640 filed on Jan. 2, 2008, entitled “Method for Creating Custom Digital Images Utilizing Background Replacement Technology Over a Network.”

Instead or in addition to transferring the digital images to a remote server, the digital images can be sent to a mobile phone. This can be achieved in various different ways.

One means of transferring a digital image to a mobile phone involves sending the digital image via a text message directly from the digital image processing unit to the mobile phone. Sometime before, during, or after the digital image is taken by the digital camera, a mobile phone number is associated with the image. This can be entered into the digital image processing unit by selecting the digital image and entering in a mobile phone number. If the digital image processing unit connects to the internet via a mobile internet card or is itself a mobile device, such as an Apple iPhone, then the digital image processing unit can simply send a text message with the digital image directly to the mobile phone.

Another means of transferring a digital image to a mobile phone involves transferring the digital image to a remote server, along with the necessary data, and then having the remote server send a text message to the mobile phone. Sometime before, during, or after the digital image is taken by the digital camera, a mobile phone number is associated with the image. This can be entered into the digital image processing unit by selecting the digital image and entering in a mobile phone number. Then, the digital image along with the associated data, including the mobile number to send the digital image to, is transferred to the remote server. After the digital image and associated data has been transferred to the remote server, the remote server can then send a text message that includes the digital image to the specified mobile number.

In an alternative method, the digital image that is printed can include a special text number and a unique ID printed on the digital image to enable mobile phone users to receive that digital image on their phone. The unique ID identifies that particular digital image and changes for each different digital image printed. A user can text the unique ID to the special text number printed on the photo. This sends a text message to the remote server or another server to process the request. If it gets sent to the remote server, then the remote server can send a text message that includes the digital image associated with the unique ID back to the mobile phone. If the text message gets sent from the mobile phone to another server, then the other server can communicate with the remote server to access the digital image and then send a text message that includes the digital image associated with the unique ID back to the mobile phone. Alternatively, instead of sending the digital image, it is contemplated that login information can be sent to the mobile phone such that the user, through his or her mobile phone, can login to the remote server to access the digital image. It is also contemplated by the inventors that a different special text number be printed on each photo. The user can then text to the special text number an email address or phone number that the digital image should be sent to. In this manner, a mobile phone user can send a digital image, or login information to access the digital image, to an email account or another mobile phone.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A system for taking and printing digital images comprising:
a digital camera, a digital image processing unit, and a printer,
where the digital camera comprises a means of wirelessly communicating with the digital image processing unit, where the digital image processing unit comprises a means of wirelessly communicating with the digital camera and a means of communicating with the printer, where the printer comprises a means of communicating with the digital image processing unit,
where the digital camera transfers digital images to the digital image processing unit, where the digital image processing unit automatically transfers the digital images it receives from the digital camera to the printer to be printed.

2. The system of claim 1, further comprising a remote server, where the remote server wirelessly communicates with the digital image processing unit, where the remote server is connected to the internet, where users can access the remote server to view digital images.

3. The system of claim 2, where the digital image processing unit automatically transfers the digital images, received from the digital camera, to the remote server.

4. The system of claim 1, where the printer wirelessly communicates with the digital image processing unit.

5. The system of claim 1, where the digital image processing unit and the printer are the same physical device.

6. The system of claim 1, further comprising a remote server, where the digital image processing unit further comprises a means of wirelessly communicating with a remote server, where the digital image processing unit obtains settings necessary to perform its functions from the remote server.

7. A method for disseminating digital images comprising the steps of:
(a) Entering settings for a first event into a remote server;
(b) Sending a digital image system to the first event, where the digital image system comprises a digital camera, a digital image processing unit, and a printer,
where the digital camera comprises a means of wirelessly communicating with the digital image processing unit, where the digital image processing unit comprises a means of wirelessly communicating with the digital camera and a means of communicating with the printer, where the printer comprises a means of communicating with the digital image processing unit,
where the digital camera transfers digital images to the digital image processing unit, where the digital image processing unit automatically transfers the digital images it receives from the digital camera to the printer to be printed;
(c) Having the digital image processing unit communicate with the remote server and download the settings for the first event;
(d) Taking a digital image with a digital camera;
(e) Transferring the digital image from the digital camera to a digital image processing unit, where the digital camera wirelessly communicates with the digital image processing unit;
(f) Transferring the digital image from the digital image processing unit to the printer; and
(g) Printing the image from the printer.

8. The method of claim 7, further comprising the steps of:
(h) Entering settings for a second event into the remote server;
(i) Sending the digital image system to the second event,
(j) Having the digital image processing unit communicate with the remote server and download the settings for the second event.

9. The method of claim 7, wherein after step (e), the digital image processing unit overlays a graphic on the digital image thereby creating a composite digital image, where the composite digital image becomes the digital image.

10. The method of claim 9, where the graphic was downloaded from the remote server.

11. The method of claim 7, further comprising the step:
(h) Transferring the digital image from the digital image processing unit to the remote server.

12. The method of claim 11, further comprising the step:
(i) making the digital image accessible over the internet.

13. The method of claim 7, where the digital image processing unit wirelessly communicates with the remote server.

14. The method of claim 7, wherein step (a), the settings are entered into a database on the remote server.

15. The method of claim 7, where the remote server is a plurality of computer servers.

16. The method of claim 7, where the digital image system further comprises an additional printer, where the digital image processing unit sends the digital images to either the printer or the additional printer to be printed.

17. A method for disseminating digital images comprising the steps of:
(a) Entering settings for a first event into a remote server;
(b) Sending a digital image system to the first event, where the digital image system comprises a digital camera, a digital image processing unit, and a printer,
where the digital camera comprises a means of wirelessly communicating with the digital image processing unit, where the digital image processing unit comprises a means of wirelessly communicating with the digital camera and a means of communicating with the printer, where the printer comprises a means of communicating with the digital image processing unit,
where the digital camera transfers digital images to the digital image processing unit, where the digital image processing unit automatically transfers the digital images it receives from the digital camera to the printer to be printed;
(c) Having the digital image processing unit communicate with the remote server and download the settings for the first event;
(d) Taking a digital image with a digital camera;
(e) Transferring the digital image from the digital camera to a digital image processing unit, where the digital camera wirelessly communicates with the digital image processing unit;
(f) Transferring the digital image from the digital image processing unit to the printer;
(g) Transferring the digital image from the digital image processing unit to the remote server; and
(h) Printing the image from the printer;

18. The method of claim 17, further comprising the steps:
(i) Entering settings for a second event into the remote server;
(j) Sending the digital image system to the second event, and
(k) Having the digital image processing unit communicate with the remote server and download the settings for the second event.

19. The method of claim 17, wherein after step (e), the digital image processing unit overlays a graphic on the digital image thereby creating a composite digital image, where the composite digital image becomes the digital image.

20. The method of claim 17, further comprising the step:
(i) making the digital image accessible over the internet.
